(19) United States
(12) Patent Application Publication
(10) Pub. No.: US 2008/0040431 A1
(43) Pub. Date: Feb. 14, 2008

(54) MONITORING AND RESPONDING TO INSTANT MESSAGING USER ACTIVITY

(76) Inventors: Troy C. Bleeker, Rochester, MN (US); Anthony M. Dunbar, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/459,704

(22) Filed: Jul. 25, 2006

(51) Int. Cl. G06F 15/16

(52) U.S. Cl. 709/206

(57) ABSTRACT

Method, system and article for responding to changes in the busy-level of a user interacting with an instant messaging (IM) application. The method includes monitoring whether the user is engaging in one or more predefined actions. Each predefined action may contribute some amount to an overall busy-level for the user. The actions may include any user activity detectable by the IM application. As tasks are initiated and completed over time, the user's busy-level increases and decreases, accordingly. When the user's busy-level threshold is reached, the IM application may be configured to set an availability status for the user to a “busy” state, preventing others from initiating a new IM conversation with that user. Once the user's busy level decreases below the threshold, the IM application automatically returns the user's status to an available state.

### CROSS-RELATED APPLICATION

This application is related to the following commonly owned application: U.S. patent application Ser. No. ______, filed on ______, 2006, entitled “METHOD AND APPARATUS FOR MANAGING INSTANT MESSAGING”, Attorney Docket No. ROC920050301US1.

### BACKGROUND OF THE INVENTION

1. Field of the Invention

The present invention is generally related to instant messaging applications. More particularly, the present invention is related to a method, article and system for monitoring and responding to the busy-level of an instant messaging user.

2. Description of the Related Art

Instant messaging (sometimes referred to herein as IM) has become a widely used means for individuals to communicate with one another in both personal and professional settings. By using an IM application, users may engage in an IM conversation by sending and receiving text messages from another user. Unlike a telephone call, it is much easier for a user to engage in multiple, discrete IM conversations simultaneously. Further, unlike a voice conference call, these conversations typically involve different and unrelated topics. Also, the timing and pace of an IM conversation may be quite varied; some involve a rapid exchange of messages being sent and received while others may proceed at a much slower pace. Typically, users of IM applications make themselves available for IM conversations with other individuals. Thereafter, any such other individuals may use the IM application to initiate a conversation. These IM conversations may come and go depending on who the user decides to inform that he or she is online and available to chat, and based on how responsive both parties are to incoming text messages from the other conversation participant.

One common problem users experience is that they become so busy with multiple IM conversations that anyone prompting a user for a new IM conversation may be ignored for no apparent reason to the requester. Further, even if the user is not engaging in any IM conversations, other activities may command the attention of a user when a request for a new IM conversation is received to the point where the requesting user is essentially ignored. Also involved in this problem is a person's ability to mufti-task. Some users can multi-task better than others. For example, one person may be able to talk on the phone and respond to one or IM conversations, while other users may have to focus exclusively on a telephone conversation.

Accordingly, there remains a need for techniques to monitor and respond to the busy-level of an instant messaging user. Such techniques should preferably account for the differences among individuals in their ability to multi-task.

### SUMMARY OF THE INVENTION

One embodiment of the invention includes a method of responding to changes in the busy-level of a user interacting with an instant messaging (IM) application. The method generally includes monitoring whether the user is engaging in one or more predefined actions, wherein each predefined action contributes to a busy-level for the user. The method generally further includes determining the busy-level of the user, and setting an availability status for the user, wherein the availability status determines whether the user is available to participate in an IM session concurrent with the one or more predefined actions being engaged in by the user.

Another embodiment of the invention includes a computer-readable medium containing a program which, when executed, performs an operation for responding to changes in the busy-level of a user interacting with an instant messaging (IM) application. The operations generally include monitoring whether the user is engaging in one or more predefined actions, wherein each predefined action contributes to a busy-level for the user. The operations generally further include determining the busy-level of the user, and setting an availability status for the user, wherein the availability status determines whether the user is available to participate in an IM session concurrent with the one or more predefined actions being engaged in by the user.

Still another embodiment of the invention includes a computing system with a memory and a processor. The memory may include a program, which, when executed on the processor performs an operation for responding to changes in the busy-level of a user interacting with an instant messaging (IM) application. The operations of the program generally include monitoring whether the user is engaging in one or more predefined actions, wherein each predefined action contributes to a busy-level for the user. The operations of the program may generally further include determining the busy-level of the user, and setting an availability status for the user, wherein the availability status determines whether the user is available to participate in an IM session concurrent with the one or more predefined actions being engaged in by the user.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrating multiple client systems communicating with one another using an IM application, according to one embodiment of the invention.

FIG. 2 is an exemplary illustration of an IM application, according to one embodiment of the invention.

FIG. 3 is an exemplary illustration of a configuration screen used to specify elements of a user's busy-level, according to one embodiment of the invention.

FIG. 4 is an exemplary illustration of an IM application showing a user participating in multiple IM conversations, according to one embodiment of the invention

FIG. 5 illustrates an exemplary IM application showing a user as busy, according to one embodiment of the invention.

FIG. 6 is a flow diagram illustrating a method for monitoring and responding to the busy-level of a user interacting with an IM application, according to one embodiment of the invention.

FIG. 7 is a flow diagram further illustrating a method for monitoring the busy-level of a user interacting with an IM application, according to one embodiment of the invention.

### DETAILED DESCRIPTION OF THE PREFERRED EMBODIMENTS

Embodiments of the present invention include a method, system, and article of manufacture for monitoring and responding to changes in the “busy-level” of a user interacting with an instant messaging (IM) application. For example, embodiments of the invention may be configured to monitor a busy-level of a user engaging in one or more IM conversations with other users. In such a case, the IM application may be configured to allow a maximum number of concurrent IM conversations before marking the user as busy.

More generally, a user's “busy-level” refers to an activity threshold that can be reached by the initiation of concurrent, ongoing tasks. Ongoing tasks can be anything detectable by the IM application. For example, a user's busy-level may be affected by some, or all, of the following:
an open instant message session with some activity in the last X number of minutes;
an open instant message session receiving a high level of input from the user;
a phone call via PBX information routed to the user;
a phone call received on a mobile phone being used to engage in an IM conversation; and
a work-station foreground task receiving a high degree of input from the user.
   Of course, which tasks impact a user's busy-level may be tailored for the circumstances of a particular case. Further, the impact on a user's busy-level may be different depending on the particular task. Thus, a user's busy-level is highly configurable. In one embodiment, users may specify a busy-level threshold and assign weights to different tasks. Additionally, a set of default values may be provided for a set of tasks monitored by the IM application. Alternatively, the IM application may assess a user's response times for IM conversations over time and dynamically adjust task weights and a busy-level threshold.

Generally, a user's busy-level may begin at zero (i.e., the user is not engaging in any tasks that would increase that user's busy-level). As tasks are initiated and completed over time, the user's busy-level increases and decreases accordingly. When the user's busy-level threshold is reached, the IM application may be configured to place the user in a “busy” state, preventing others from initiating a new IM conversation with that user. Once the user's busy level decreases below the threshold, the IM application automatically returns the user's status to an available state.

Embodiments of the invention may be used by individuals engaging in IM conversations as agents of a “virtual help-desk.” In such a case, an agent may accept additional IM conversations requests from customers, so long as their busy level is not exceeded by taking on an additional request. Doing so may limit the response time customers experience with an on-line agent, increasing customer satisfaction. This may also prevent such an agent from being overwhelmed by a large number of simultaneous IM conversations.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

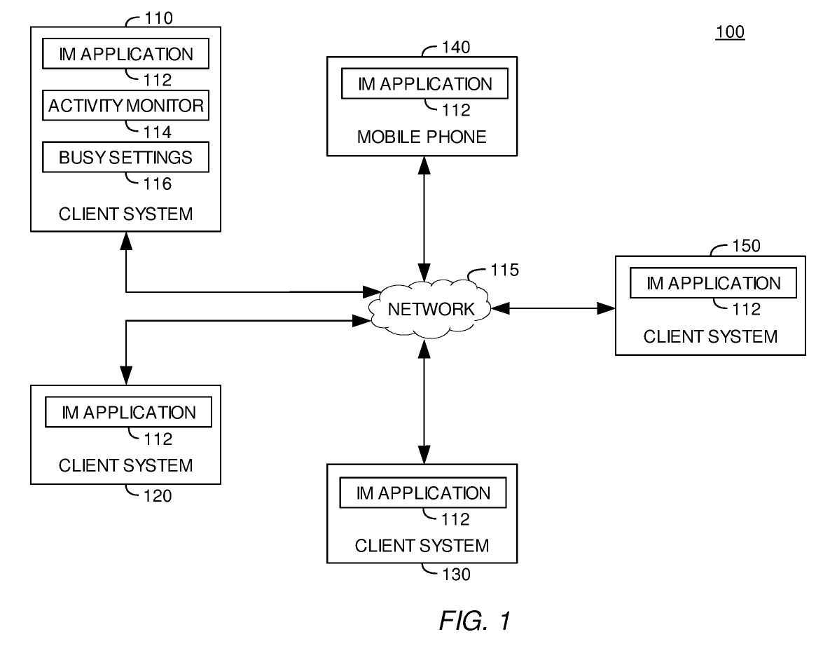

One embodiment of the invention is implemented as a program product for use with computer systems such as, for example, the computing environment 100 shown in FIG. 1 and described below. The program(s) of the program product defines functions of the embodiments (including the methods described herein) and can be contained on a variety of computer-readable media. Illustrative computer-readable media include, but are not limited to: (i) information permanently stored on non-writable storage media (e.g., read-only memory devices within a computer such as CD/DVD-ROM disks readable by a CD/DVD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. Computer programs of the present invention typically are comprised of a multitude of instructions that will be translated by the native computer into a machine-readable format and hence executable instructions. Also, programs include variables and data structures that may reside locally in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

FIG. 1 is a block diagram illustrating multiple client systems 110, 120, 130, 140 and 150 communicating with one another using an IM application 112, according to one embodiment of the invention.

Client systems 110, 120, 130, 140, and 150 show a simplified representation of a variety existing computer systems, e.g., desktop computers, server computers, laptop computers, tablet computers, and the like. Additionally, the client systems may be representative of other computing devices such as PDA's (personal digital assistants) and WML (wireless markup language) enabled mobile phones (e.g., mobile phone 140). The invention, however, is not limited to any particular computing system, device or platform and may be adapted to take advantage of new computing systems and devices as they become available. Network 115 may represent any suitable network, including small local area networks, corporate intranets, large wide area networks such as the Internet, or any combination thereof.

As shown, client systems 110, 120, 130, 140, and 150 include an IM application 112 configured to allow one user to engage in an IM conversation with other users. One common example of an IM application 112 includes the Sametime® application available from IBM. However, embodiments of the invention may be adapted for use with any of the numerous commercially available IM applications 112.

As shown, in addition to IM application 112, client 110 includes an activity monitor 114 and busy settings 116. Although shown as discrete components, one of ordinary skill in the art will recognize that activity monitor 114 and/or busy settings 116 may be integrated with IM application 112. As described in greater detail herein, activity monitor 114 may be configured to monitor the busy-level of a user and change that user's IM availability from busy to available, and back, as that user engages in various tasks monitored by activity monitor 114. Busy settings 116 may specify which tasks are monitored by activity monitor 114, the impact of each monitored task on a user's busy-level, as well as the busy threshold for a given user.

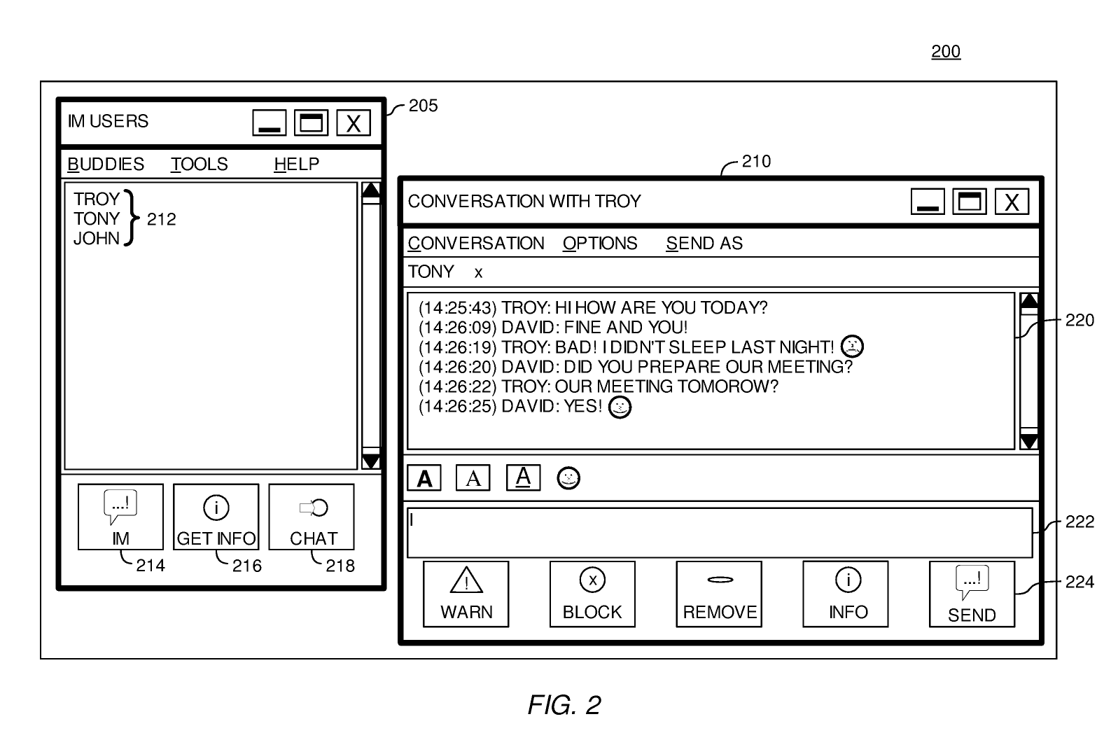

FIG. 2 is an exemplary illustration of an on-screen interface 200 provided by IM application 112, according to one embodiment of the invention. As shown, IM application 112 includes a user list window 205 and an IM conversation window 210. In this example, windows 205 and 210 show a variety of features found in many IM applications 112 (e.g., IBM's Sametime® IM application). Of course, depending on the IM application 112 used in a particular case, some, all, or different features may be provided.

As shown, window 205 includes a list 212 of other users currently online that may be sent an instant message. Generally, a user may send an instant message by selecting one of the users from lists 212 and pressing “IM” button 214. In response, IM application 112 may display a dialog box allowing the user to enter content for an instant message and send the instant message. Information about a user from list 212 may be displayed using “get info” button 216.

“Chat” button 218 may be used to initiate an IM conversation with one of the users in list 212. Generally, a user may initiate an IM conversation by selecting one of the users from list 212 and pressing button 216. In response IM application 112 may be configured to display a window such as conversation window 210. In this example, conversation window 210 shows a conversation between an IM application user named “David” and another named “Troy.” FIG. 2 shows “David's” side of the IM conversation.

In addition to conversation content 220, conversation window 210 includes a text area 222 for a user to enter new content for an ongoing conversation. Generally, as is known, a user simply types a desired message and presses “send” button 224 to send a new message to another participant to an IM conversation. Conversation content 220 displays the IM conversation as it occurs between users. Conversation window 210 also includes a variety of other interface components commonly found in an IM application 112 not described in detail.

In one embodiment, when a user presses “chat” button 218 to initiate a new IM conversation, the IM application 112 receiving the users request may determine whether the receiving user's status is currently set to “busy.” If so, the user requesting the new IM conversation may be presented with an indication that the other user is currently unavailable. Further, list 212 may display an indication of a status (e.g., “available” or “busy”) for each user in the list.

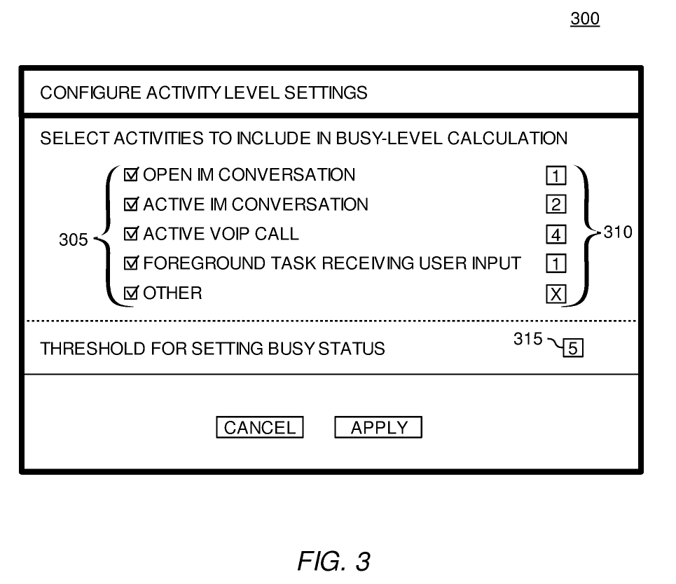

As stated, in one embodiment, the determination of whether a given user is “available” or “busy” may be determined by an activity monitor 114 using a busy-level threshold specified in configuration settings 116. FIG. 3 is an exemplary illustration of a configuration screen 300 used to specify components of a user's busy-level, according to one embodiment of the invention (i.e., screen 300 allows a user to specify configuration settings 116).

As shown, configuration screen 300 includes a set of checkboxes 305, activity scores 310, and threshold setting 315. Generally, screen 310 may allow a given user to configure which activities, contribute to that user's busy-level, how much each activity contributes, and a threshold of how “busy” a user must be before that user's status is set to “busy.”

In this illustration, a user has selected to include each of the available options to contribute to a busy-level. Thus, each “open IM conversation,” each “active IM conversation,” any “active voice calls,” and any “foreground tasks receiving user input” are included in the busy level calculation. Activity scores 310 specify an amount to contribute to a busy-level calculation for each selected activity. Note, as stated, any ongoing tasks that may be detected by IM application 112 may contribute to the busy-level of a given user. Of course, the actual selection (and weight) of activities may depend on a variety of factors and tailored to suit the needs of a particular user. For example, for an IM application 112 running on mobile telephone 140, the only monitored activity might be whether the user is engaged in a voice telephone conversation, in which case the user is set to “busy” for purposes of an IM conversation for the duration of the voice telephone conversation.

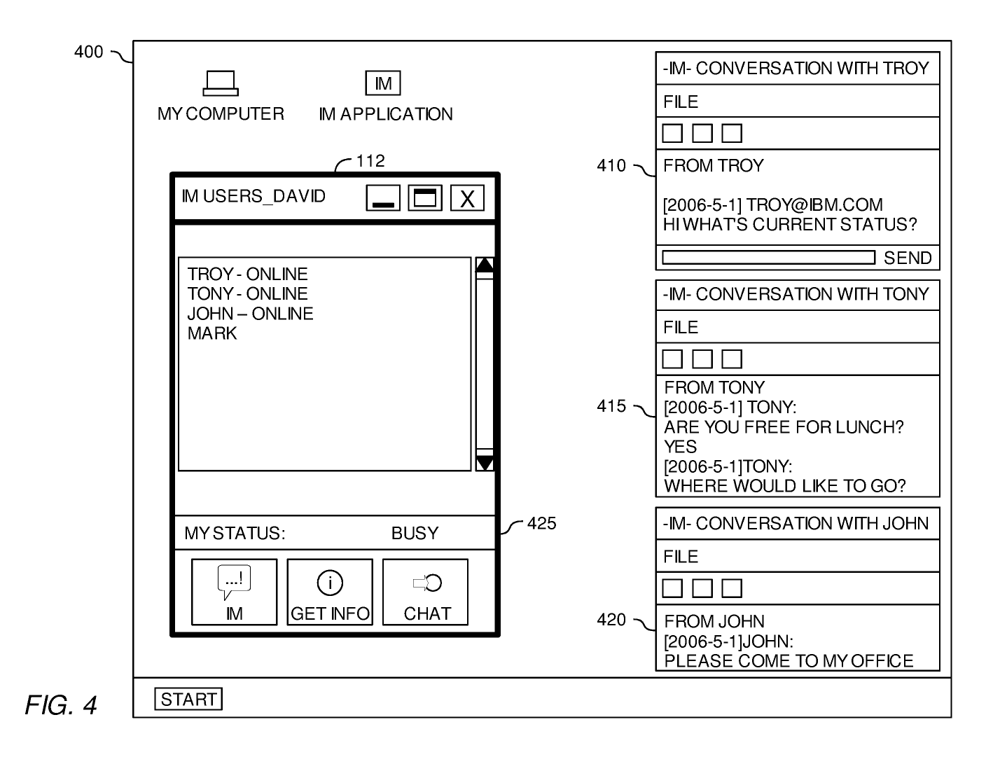

FIG. 4 is an exemplary illustration 400 of an IM application where a user is participating in multiple IM conversations, according to one embodiment of the invention. As shown the IM user “David” has three open IM conversations. Specifically, conversation window 410 shows an IM conversation with “Troy;” conversation window 415 shows an IM conversation with “Tony” and conversation window 420 shows an IM conversation with “John.” Assume that the user “David” has set configuration settings 116 using the settings illustrated in FIG. 3. Thus, each active IM conversation contributes “2” points to this user's busy-level. Because the total busy-level level (6) exceeds the busy level threshold (5) activity monitor 114 will set this user's IM status to busy. In one embodiment, the user's IM application 112 may provide an indication of the user's current status. For example, as shown in FIG. 4 “David's” status indication 425 is set to “busy.” If “David” were to close one of the IM conversations occurring in windows 410, 415, and 420, then his busy-level drops to (4), below his busy-level threshold. When this occurs, activity monitor 114 changes “David's” status back to available. Status indication 425 would then reflect such a change.

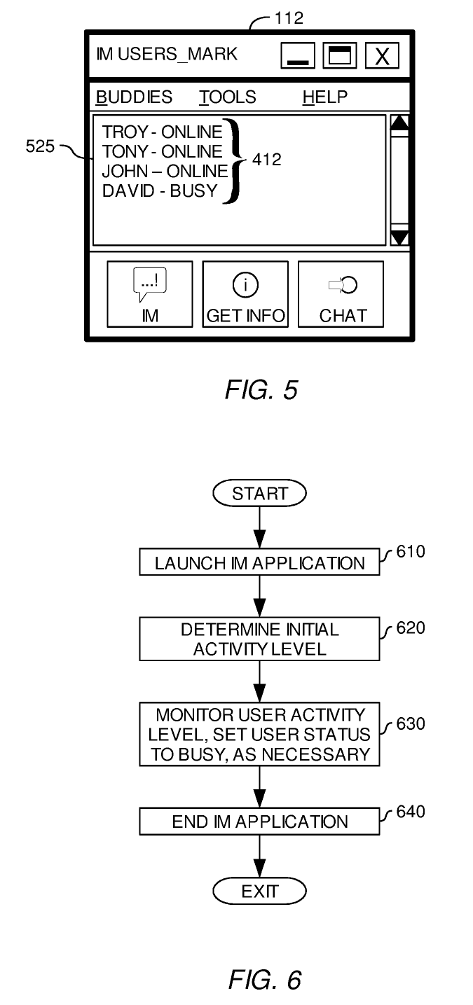

While “David's” busy-level exceeds the threshold specified in configuration settings 116, “David's user status may be displayed as busy by the IM application 112 used by other users. For example, FIG. 5 illustrates an exemplary IM application 112 showing “David” as busy, according to one embodiment of the invention. As shown, IM application is being used by a user named “Mark.” User list 412 includes four users, and shows the status of each one.

FIG. 6 is a flow diagram illustrating a method 600 for monitoring and responding to the busy-level of a user interacting with an IM application 112, according to one embodiment of the invention.

As shown, the method 600 begins at step 610 where a user launches an IM application 112. At step 620, the user's initial busy-level is determined. In one embodiment, activity monitor 114 may determine whether any of the events specified in configuration settings 116 are occurring. For example, the list of monitored events in FIG. 3 includes “foreground tasks receiving user input.”

Thus, if the user launched IM application 112 while also working on a word processing document, the initial busy level calculated at step 620 would reflect this activity.

A step 630, activity monitor 114 monitors user activity while the IM application is running. As the user engages in various activities, the user's busy-level may increase and decrease. Additionally, whenever the user's busy level increases above (or decreases below) the busy-level threshold specified in configuration settings 116, then activity monitor 114 may change the user's status to “busy” or “available,” accordingly. At step 640, the user may end an IM session by closing IM application 112.

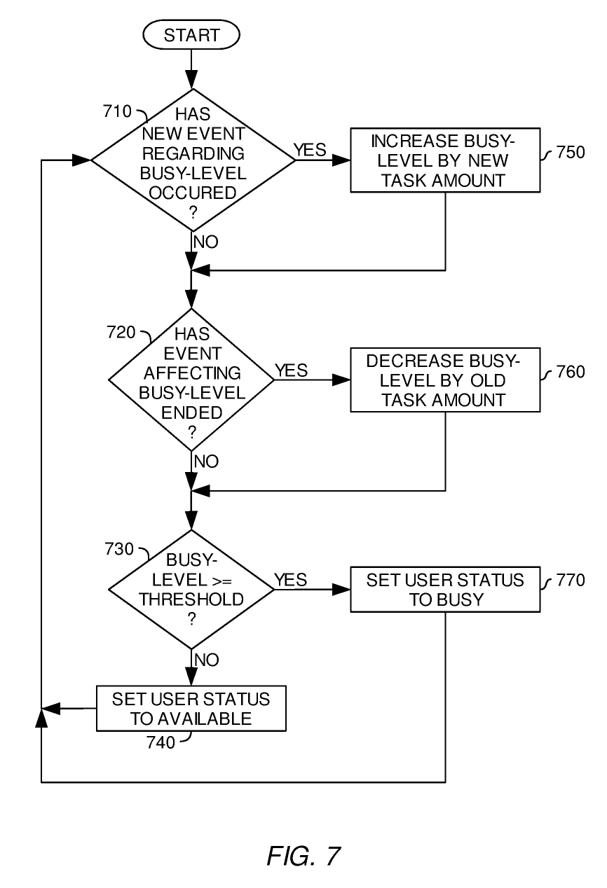

FIG. 7 is a flow diagram further illustrating a method 700 for monitoring the busy-level of a user interacting with IM application 112, according to one embodiment of the invention. The method 700 illustrates actions that may be performed by activity monitor 114 as part of step 630 of the method 600.

Method 700 beings at step 710 where the activity monitor 114 may determine whether a monitored event has occurred. For example, a user may initiate a new task, or a user may receive a request from another user to begin an IM conversation. More generally, at step 710, activity monitor 114 determines whether any event specified in configuration settings 116 has occurred. If so, the activity monitor 114 may increase the user's busy-level by the amount specified configuration settings 116 (step 750).

After determining whether to increase a user's busy level, the activity monitor determines whether any monitored events have occurred to decrease the user's busy level (step 720). For example, a user may conclude an IM conversation or telephone conversation, or a task that was receiving user input (increasing the user's busy level) may no longer be receiving user input. If so, the activity monitor 114 decreases the user's busy-level by the appropriate amount as specified in configuration settings 116 (step 760).

At step 740, after making the appropriate adjustments to the user's busy level, the activity monitor determines whether the busy-level is above or below the threshold specified in configuration settings 116. If above the threshold, then, at step 770, the activity monitor 114 sets the user's status to “busy.” If below the threshold, then, at step 740, the activity monitor 114 sets the user's status to “available.” Alternatively, rather than set the user's status on each pass through the method 700, the activity monitor 114 may only set a user's status, if after calculating any changes to the user's busy level as part of steps 710 and 720, the status has transitioned from one (i.e., from “busy” to “available” or vice-versa).

While the foregoing is directed to embodiments of the present invention, other and further embodiments of the invention may be devised without departing from the basic scope thereof, and the scope thereof is determined by the claims that follow.

What is claimed is:

1. A method of responding to changes in a busy-level of a user interacting with an instant messaging (IM) application, comprising:
monitoring whether the user is engaging in one or more predefined actions, wherein each predefined action contributes to the busy-level for the user;
determining the busy-level of the user on the basis of the monitored one or more predefined actions; and
setting an availability status for the user on the basis of the determined busy-level status of the user, wherein the availability status determines whether the user is available to participate in an IM session concurrent with the one or more predefined actions being engaged in by the user.

2. The method of claim 1, wherein the IM session availability status is set to one of an “available” status and a “busy” status based on a threshold setting for the busy-level of the user.

3. The method of claim 2, wherein the “available” status allows other individuals to initiate a new IM session with the user, and the “busy” status prevents other individuals from initiating a new IM session with the user.

4. The method of claim 1, wherein each IM session is a text based conversation between the user and another individual carried out using the IM application.

5. The method of claim 1, further comprising, dynamically updating the user's availability status while the user interacts with the IM application.

6. The method of claim 1, further comprising, prior to monitoring whether the user is engaging in one or more predefined actions:
launching the IM application;
determining an initial busy-level of the user; and
setting the availability status of the user, based on the initial busy-level.

7. The method of claim 1, wherein the IM application is running on one of a mobile phone, personal digital assistant, and a wireless handheld device.

8. The method of claim 1, wherein the one or more predefined actions include at least: one or more active IM sessions receiving input from the user, a user engaging in a telephone conversation concurrent with an IM session; and one or more other applications actively receiving input from the user.

9. The method of claim 8, wherein the telephone call is received on a mobile telephone being used for the IM session.

10. A computer-readable medium containing a program which, when executed, performs an operation for responding to changes in a busy-level of a user interacting with an instant messaging (IM) application, comprising:
monitoring whether the user is engaging in one or more predefined actions, wherein each predefined action contributes to the busy-level for the user;
determining the busy-level of the user on the basis of the monitored one or more predefined actions; and
setting an availability status for the user on the basis of the determined busy-level status of the user, wherein the availability status determines whether the user is available to participate in an IM session concurrent with the one or more predefined actions being engaged in by the user.

11. The computer-readable medium of claim 10, wherein the IM session availability status is set to one of an “available” status and a “busy” status based on a threshold setting for the busy-level of the user.

12. The computer-readable medium of claim 11, wherein the “available” status allows other individuals to initiate a new IM session with the user, and the “busy” status prevents other individuals from initiating a new IM session with the user.

13. The computer-readable medium of claim 10, wherein each IM session is a text based conversation between the user and another individual carried out using the IM application.

14. The computer-readable medium of claim 10, further comprising, dynamically updating the user's availability status while the user interacts with the IM application.

15. The computer-readable medium of claim 10, further comprising, prior to monitoring whether the user is engaging in one or more predefined actions:
launching the IM application;
determining an initial busy-level of the user; and
setting the availability status of the user, based on the initial busy-level.

16. The computer-readable medium of claim 10, application is running on one of a mobile phone, personal digital assistant, and a wireless handheld device.

17. The computer-readable medium of claim 10, wherein the one or more predefined actions include at least: one or more active IM sessions receiving input from the user, a user engaging in a telephone conversation concurrent with an IM session; and one or more other applications actively receiving input from the user.

18. The computer-readable medium of claim 17, wherein the telephone call is received on a mobile telephone being used for the IM session.

19. A computing system, comprising:
a memory; and
a processor; and a program, which, when executed on the processor performs an operation for responding to changes in a busy-level of a user interacting with an instant messaging (IM) application, comprising:
monitoring whether the user is engaging in one or more predefined actions, wherein each predefined action contributes to the busy-level for the user;
determining the busy-level of the user on the basis of the monitored one or more predefined actions; and
setting an availability status for the user on the basis of the determined busy-level status of the user, wherein the availability status determines whether the user is available to participate in an IM session concurrent with the one or more predefined actions being engaged in by the user.

20. The computing system of claim 19, wherein the IM session availability status is set to one of an “available” status and a “busy” status based on a threshold setting for the busy-level of the user.

21. The computing system of claim 19, further comprising, dynamically updating the user's availability status while the user interacts with the IM application.

22. The computing system of claim 19, wherein the computing system is selected from one of a mobile phone, personal digital assistant, and a wireless handheld device.

23. A method of responding to changes in a busy-level of a user interacting with an instant messaging (IM) application, comprising:
setting an availability status for the user on the basis of a user's current activity level in a computer environment, wherein the availability status determines whether the user is available to participate in an IM session concurrent with the user's current activities being engaged in by the user in the computer environment.
